(19) United States
(12) Patent Application Publication
(10) Pub. No.: US 2003/0172567 A1
(43) Pub. Date: Sep. 18, 2003

(54) Rod-mountable message body

(76) Inventors: Gal-David Zentner, Tel-Aviv (IL); Elad Zentner, Tel-Aviv (IL)

Correspondence Address: Eitan, Pearl, Latzer & Cohen Zedek, LLP., Suite 1001, 10 Rockefeller Plaza, New York, NY, 10020, US

(21) Appl. No.: 10/230,405

(22) Filed: Aug. 29, 2002

(30) Foreign Application Priority Data
Aug. 30, 2001 (IL) 145193

(51) Int. Cl. G09F 21/04

(52) U.S. Cl. 40/591

(57) ABSTRACT

The invention relates to a message display means which comprises a solid body which can be assembled to a part of a rod such as a flag end, or a radio antenna of a telephone or of a vehicle, at least one of the outer faces of said body being configured to carry a textual and/or pictorial message.

### RELATED APPLICATIONS

This application claims priority of Israeli application number 145193, filed on Aug. 30, 2001, which is incorporated in its entirety by reference herein.

### FIELD AND BACKGROUND OF THE INVENTION

The present invention relates to the display of a message for personal or commercial purposes. More particularly, the invention provides a solid body which can be assembled to a part of a rod such as a flag end, or a radio antenna of a telephone or of a vehicle, at least one of the outer faces of said body being configured to carry a textual and/or pictorial message.

Vehicles have long been used for advertising purposes, whether of a commercial nature or for publicizing slogans of a personal, political, sports-related or humorous content. Probably the most widely-used device is the bumper sticker. Also seen on vehicles are flags, window stickers and advertising sunshade boards. The outer faces of the vehicle itself are also used for advertisements in some commercially-used and owned vehicles. In U.S. Pat. No. 6,085,687 Chester discloses a flag mount for a vehicle luggage rack. Sandeen et al. in U.S. Pat. No. 4,901,662 propose a windsock to be mounted on the radio antenna of a vehicle. The drawback of flexible devices such as flags and windsocks is that the displayed message can only be read for the minority of the time that a vehicle is in motion causing an air stream to extend the material carrying the text, and yet can only be read by a bystander if the vehicle in moving slowly.

Cellular mobile radio telephones (henceforth referred to as cell phones) are now in extensive use in Vehicles, yet little if any use has been made of these devices for the purpose of advertising.

### OBJECTS OF THE INVENTION

It is therefore one of the objects of the present invention to propose a new means of advertising which can be seen and read independently of whether or not it is exposed to an air stream. It is a further object of the present invention to provide a device whose form can be adapted to relate to the message content, for example a spherical body promoting a football game or team. Yet a further object of the invention is to provide a low-cost base for an advertising message which can easily be discarded and replaced by another body carrying a new slogan.

The present invention achieves the above objects by providing a message-carrying rod-mountable body, the body being rigid and being provided with a recess for at least indirectly mounting onto an extremity of a rod.

In a preferred embodiment of the present invention there is provided a rod-mountable body, wherein the body is sized for use on the antenna of a radio telephone.

In a most preferred embodiment of the present invention there is provided a rod-mountable body wherein the body is a hollow plastic body sized for use on a vehicle radio antenna.

Yet further embodiments of the invention will be described hereinafter.

It will thus be realized that the novel device of the present invention serves to provide a new platform for the display of any short message - whether for personal, political, commercial or other purposes. The low cost of the device is suitable for advertising purposes. The size of the device is in proportion to the application. Vehicle antenna devices will be about plum size, devices for flag tops can be up to about tennis ball size. Referring again to the device attached to a vehicle antenna, the allowed maximum size can be extended by use of an aerodynamic shape so as to reduce drag and reduce stress on the antenna when the vehicle is in motion. As opposed to flags and windsocks, the transcribed text on the device of the present invention may be read at any time, and in the case of a vehicle antenna device, may be read whether the vehicle is moving or is stationary. Telescoping radio antennas are often fitted with a stepped end cap at the outer extremity. This cap may be removed to reveal a screw-threaded section. In some embodiments of the present invention a captive nut insert is provided which can be arranged to mate directly with the screwed antenna extremity. Some modem automobiles carry an automatically-retracting radio antenna. The present invention provides an embodiment wherein the body of the message-carrying device remains undisturbed and visible despite the retraction.

It is within the scope of the invention to use the message carrying body to decorate birthday cakes, dishes and the like use.

With regard to commercial and sports advertising there is clearly much scope for relating the shape of the device of the present dimension to the content of the message displayed thereon. A spherical device can advertise a football game, a disk-shaped device a pizza eatery, a tent-shaped device a camping supplies vendor and the like.

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is a perspective view of a preferred embodiment of the message-carrying rod-mountable body according to the invention;

FIG. 2 is a perspective, partly sectioned view of a rod-mountable body having a screw-threaded recess;

FIG. 3 is a view of a perspective view of a rod-mountable body for a vehicle;

FIG. 4 is a partially-sectioned elevational view of an embodiment including an adapter; and

FIG. 5 is a perspective view of an embodiment for use on a vehicle antenna.

### DETAILED DESCRIPTION OF THE PREFERRED EMBODIMENT

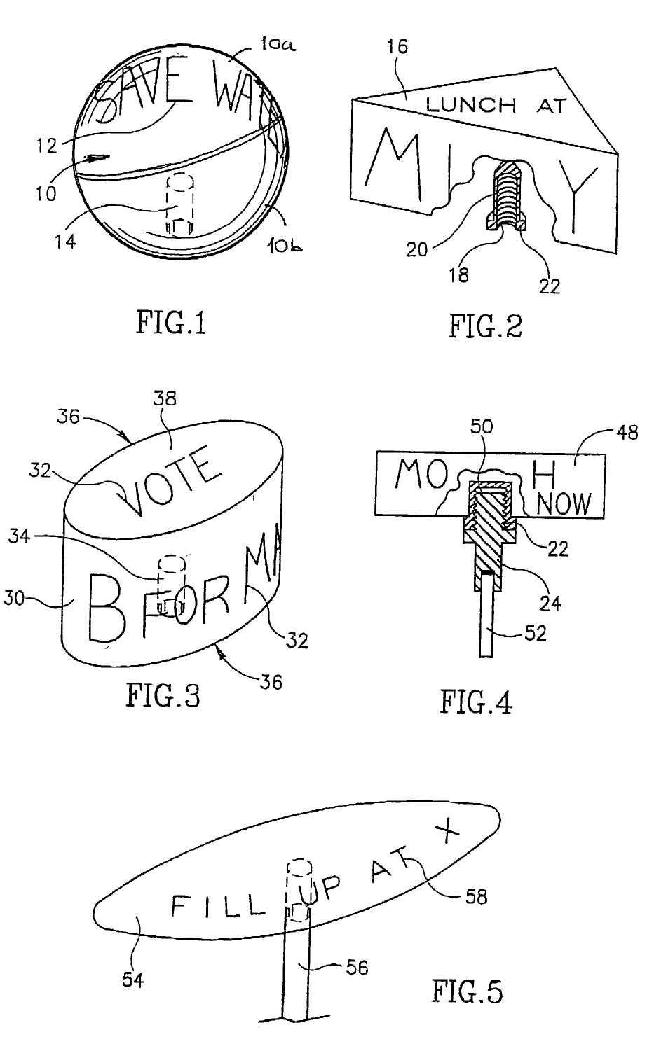

There is seen in FIG. 1 a message-carrying rod-mountable body 10. In the present embodiment the body 10 is intended for mounting on top of a flagpole (not seen) or any other suitable rod or an antenna. The body 10 is rigid and light weight, preferably being made of a foamed plastic, suitably a closed-cell polystyrene foam. The body 10 has a basic geometric shape, a sphere in the present embodiment. The message 12 in the present embodiment is printed directly onto the foamed plastic. However if the body 10 as molded does not provide a satisfactory surface for printing, the body 10 can be coated by spraying or dipping to achieve the required surface, while at the same time providing the chosen background color. A recess 14 of an appropriate diameter and depth is provided for mounting the body 10 onto an extremity of the rod projecting above the flag or directly on an antenna of a vehicle. Alternatively the body 10 could be a hollow plastic body made of two parts 10a and 10b joint together enclosing the tip of the antenna.

Referring now to FIG. 2, there is seen a rod-mountable body 16, wherein the recess 18 is screw threaded. The screw thread 20 is formed inside a retained shoulder bush 22, which can be made of brass. The screw thread 20 may be utilized either for directly connecting to a rod (not shown) or for retaining an adapter 24, seen in FIG. 4, which is then connected to a rod.

Seen in FIG. 3 is a rod-mountable body 36, wherein the body is sized at about 2 - 4 cm, for use on a vehicle radio antenna (not seen). Both the roof 38 and the sides 30 of the body 36 are shown being used to display a message 32. A suitable mounting recess 34 is located on the lower face 36.

Referring now to FIG. 4, there is depicted a rod-mountable marquise-shaped body 48 wherein the recess 50 is arranged to hold an adapter 24 which can be secured to the extremity of a radio antenna 52.

The adapter 24 is sufficiently long to allow the body 48 to project outside the vehicle it serves after antenna retraction. Such an adaptor or any other shape or configuration could be used.

FIG. 5 shows a vehicle radio-antenna-mountable body 54 wherein the body is shaped as an aerodynamic element. Such shape is important because of the reduced drag when the vehicle being served moves at high speed, in order not to over-stress the antenna 56. The streamlined shape allows the use of a larger body, and therefor makes possible the display of a larger or longer message 58.

The scope of the described invention is intended to include all embodiments coming within the meaning of the following claims. The foregoing examples illustrate useful forms of the invention, but are not to be considered as limiting its scope, as those skilled in the art will readily be aware that additional variants and modifications of the invention can be formulated without departing from the meaning of the following claims.

We claim:

1. A message-carrying rod-mountable body, said body being rigid and being provided with a recess for at least indirectly mounting onto an extremity of said rod.

2. The rod-mountable body as claimed in claim 1, wherein said body is made of a foamed plastic.

3. The rod-mountable body as claimed in claim 1, wherein said body is a hollow spheric body made of two parts.

4. The rod-mountable body as claimed in claim 1, wherein said recess is screw threaded.

5. The rod-mountable body as claimed in claim 1, wherein said rod is a radio antenna.

6. The rod-mountable body as claimed in claim 5, wherein said recess is sized for direct insertion therein of the extremity of a radio antenna.

7. The rod-mountable body as claimed in claim 1, wherein said body is sized for use on the antenna of a radio telephone.

8. The rod-mountable body as claimed in claim 1, wherein said body is sized for use on a vehicle radio antenna.

9. The rod-mountable body as claimed in claim 1, wherein said recess is arranged to hold an adapter which can be secured to the extremity of a radio antenna.

10. The rod-mountable body as claimed in claim 8, wherein said adapter is sufficiently long to allow said body to project outside the vehicle after antenna retraction.

11. The rod-mountable body as claimed in claim 8, wherein said body is shaped as an aerodynamic element.
